(19) United States
(12) Patent Application Publication
(10) Pub. No.: US 2006/0093710 A1
(43) Pub. Date: May 4, 2006

(54) Beverage container with juice extracting feature

(76) Inventor: Timothy A. Bengtson, Lawrence, KS (US)

Correspondence Address: BLACKWELL SANDERS PEPER MARTIN LLP, 4801 Main Street, Suite 1000, KANSAS CITY, MO, 64112, US

(21) Appl. No.: 10/979,936

(22) Filed: Nov. 2, 2004

(51) Int. Cl. A23B 7/148

(52) U.S. Cl. 426/106

(57) ABSTRACT

A beverage container such as a tumbler or pitcher is provided on its inside surface with a series of protrusions which extract juice and pulp when a citrus fruit is rubbed against them. The protrusions may extend from a patch secured to the inside of the container. The protrusions may be arranged in rows and columns and may taper to a flat tip.

### CROSS-REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

This invention relates in general to beverage containers such as drinking glasses and pitchers. More particularly, the invention is directed to a beverage container that is specially constructed to allow fruit juice to be conveniently extracted and added to a beverage in the container.

### BACKGROUND OF THE INVENTION

A wide variety of beverages can be enhanced with fruit slices or wedges or the juice and pulp from citrus fruits. For example, water, iced tea, soft drinks and mixed drinks often have slices of fruit added to them or fruit juice and/or pulp squeezed into them. Citrus fruit such as lemons, limes, oranges and grapefruits are commonly used for this purpose. A slice or wedge of fruit can be added to a glass or tumbler that holds the beverage, or the fruit can be squeezed with the hands or with the aid of an implement to extract the juice and/or pulp which is thus added to the beverage contained in the glass or pitcher.

### SUMMARY OF THE INVENTION

The present invention is directed to a beverage container such as a tumbler, glass, pitcher or other receptacle which is provided on its inside surface with a series of protrusions that are characterized by the ability to extract the juice and/or pulp from a fruit which is rubbed against them.

Preferably, the protrusions are arranged in a selected pattern on a patch that is secured to the inside surface of the container slightly below its rim. In the case of a pitcher, the patch is offset from the spout to avoid interfering with normal pouring of the beverage. In the case of all containers, the patch preferably occupies only a portion of the inside surface so that normal flow of the beverage out of the container is not obstructed. The protrusions may advantageously be spaced apart both horizontally and vertically for effective extraction of juice when the fruit is pressed against them and rubbed. Arrangement of the protrusions in horizontal rows and vertical columns has been found to be an effective pattern.

The protrusions may take various sizes and shapes, but protrusions that taper as they extend away from the inside surface of the container are preferred. Also, the protrusions preferably have flattened tips so that sharp points are avoided and the protrusions can effectively extract juice by pressure rather than by cutting action.

Other and further objects of the invention, together with the features of novelty appurtenant thereto, will appear in the course of the following description.

### BRIEF DESCRIPTION OF THE SEVERAL VIEWS OF THE DRAWINGS

In the accompanying drawings which form a part of the specification and are to be read in conjunction therewith and in which like reference numerals are used to indicate like parts in the various views:

FIG. 1 is a perspective view of a tumbler constructed according to a preferred embodiment of the present invention;

FIG. 2 is a perspective view on an enlarged scale of the patch and protrusions which are applied to the inside surface of the tumbler shown in FIG. 1;

FIG. 3 is a fragmentary sectional view on an enlarged scale taken generally along line 3-3 of FIG. 1 in the direction of the arrows; and

FIG. 4 is a perspective view of a beverage pitcher constructed according to a modified embodiment of the invention.

### DETAILED DESCRIPTION OF THE PREFERRED EMBODIMENT

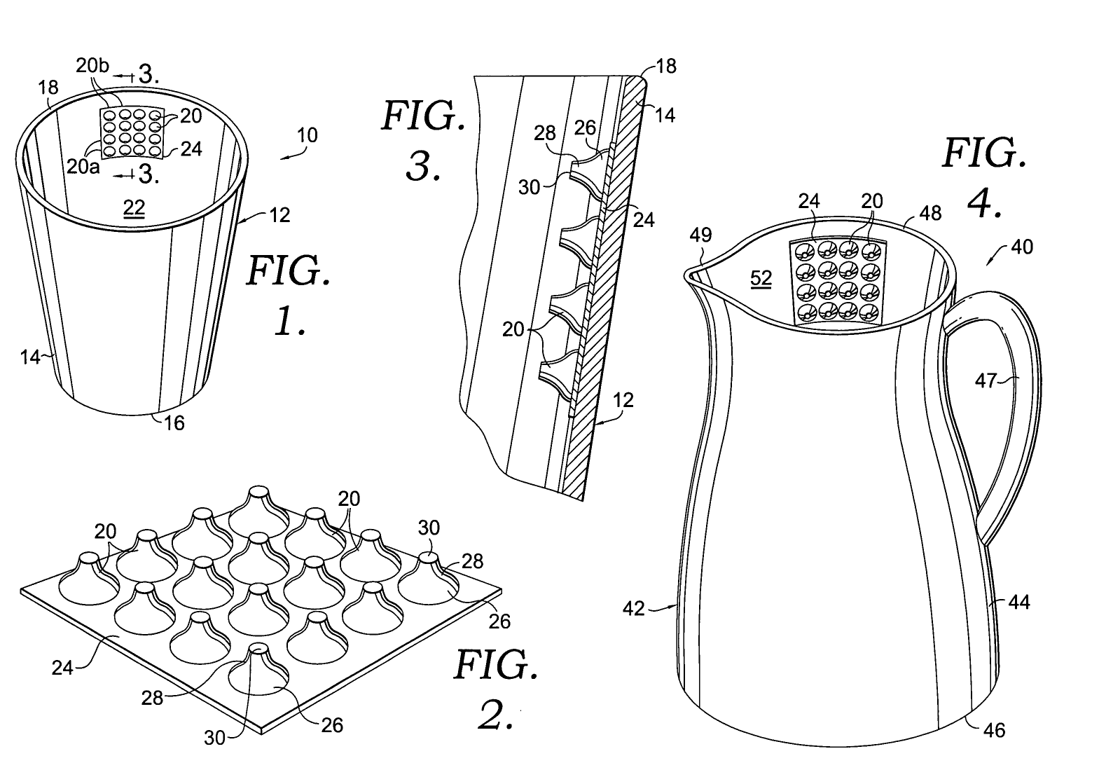

Referring now to the drawings in more detail and initially to FIG. 1, numeral 10 generally designates a drinking glass or tumbler which has a conventional construction for the most part. The tumbler 10 has a hollow container body 12 which includes a frusto-conical wall 14 and a closed bottom 16. The container body 12 provides a receptacle in which beverages may be received and held. The container body 12 terminates in a circular top rim 18. The tumbler 10 may be constructed of any suitable material.

In accordance with the present invention, a plurality of protrusions 20 are provided on the inside surface 22 of the container wall 14. Surface 22 may be smooth except where the protrusions are located. The protrusions 20 preferably extend from a thin patch 24 which is suitably secured to the surface 22, as by gluing or in any other suitable manner. Alternatively, the protrusions 20 may be formed as part of the wall 14 or may be mounted on the wall in a different manner.

As shown additionally in FIGS. 2 and 3, the patch 24 may be a thin flat panel having a substantially square configuration. The protrusions 20 may be arranged on the patch 24 in a plurality of horizontal rows 20a (FIG. 1) and a plurality of vertical columns 20b (FIG. 1). By way of example, the embodiment illustrated in the drawings include four of the protrusions 20 in each horizontal row 20a and four of the protrusions 20 in each vertical column 20b. The protrusions 20 in each row are spaced equidistantly apart, as are the protrusions in each of the columns. Thus, sixteen of the protrusions 20 may be provided on the patch 24, with the protrusions spaced apart both horizontally and vertically when the patch 24 is applied to surface 22.

The protrusions may be provided in a different pattern and in different numbers. For example, there may be rows and columns having five protrusions each for a total of 25 protrusions. Similarly, rows and columns each containing six protrusions can be provided for a total of 36 protrusions.

With reference to FIG. 2 in particular, each protrusion preferably has a tapered shape and includes a relatively large bulbous base 26 which generally tapers as it extends away from the patch 24. Each protrusion 20 may terminate at its free end in a relatively small tip 28 which preferably presents a flat surface 30. The flat surfaces 30 are advantageous in that they avoid presenting sharp points that could be a safety problem. Additionally, as will be explained more fully, the flat surfaces 30 enhance the ability of the protrusions to extract juice and pulp by pressure rather than cutting action. By way of example, the protrusions 20 may each have a diameter of approximately 3/16 inch at the base 26. Each of the flat surfaces 30 may be spaced away from the patch 24 by a distance of approximately ⅛ inch.

As a typical example for an ordinary tumbler 10, the patch 24 may have a width in the range of approximately 1-1½ inches and a height in the range of approximately 1-1½ inches. The patch 24 may be applied to surface 22 at a location wherein the patch is spaced below the rim 18 by a distance in the range of approximately ¼-½ inch.

As previously indicated, the patch 24 may be glued or otherwise secured to a selected portion of the inside surface 22 of the container body 12. The container 10 is suitable for receiving various types of beverages, including water, iced tea, soft drinks of various types and mixed drinks. A cut piece of a fruit such as a slice or wedge of lemon, lime, orange or grapefruit can be grasped in the hand and pressed against the protrusions 20 and rubbed in order to extract juice and/or pulp from the fruit by pressure applied by the protrusions 20. The juice and/or pulp that is extracted runs downwardly along surface 22 and is thus added to the beverage in the container 10.

In this manner, the protrusions 20 provide a convenient means for extracting juice and/or pulp from fruits and particularly citrus fruits. The beverage in the container 10 is thus enhanced with a fresh citrus flavor and the addition of pulp if desired. Additionally, the activity involved in rubbing the fruit piece against the protrusions 20 is enjoyable for the user. The protrusions 20 provide a novel feature that is appealing for these reasons as well as its unusual nature.

FIG. 4 illustrates a beverage pitcher which is generally identified by numeral 40. The pitcher 40 has a contoured container body 42 that provides a receptacle for receiving and holding various types of beverages. The container body 42 has a wall 44 and a bottom 46. A handle 47 is provided on the outside surface of the wall 44. The top of the container body 42 is open and terminates in a top rim 48 which presents a conventional spout 49 through which the beverage can be poured from the container 40.

The container body 42 has an inside surface 52 to which the patch 24 with protrusions 20 may be applied. As with the tumbler 10, the protrusions 20 can be mounted in another fashion if desired. In the case of the pitcher 40, the patch 20 is situated at a location offset or displaced from the spout 49 in order to avoid interfering with the smooth pouring of liquid through the spout 49. Because the pitcher 40 is typically considerably larger than the tumbler 10, the patch 20 applied to pitcher 40 may be larger than the patch 20 applied to the tumbler 10 and may be twice as large by way of example.

The protrusions 20 on the pitcher 40 are used in the same manner as in the case of the tumbler 10, and the beverage in the pitcher 40 may be enhanced with a fresh citrus flavor and/or pulp in the amount desired.

From the foregoing it will be seen that this invention is one well adapted to attain all ends and objects hereinabove set forth together with the other advantages which are obvious and which are inherent to the structure.

It will be understood that certain features and subcombinations are of utility and may be employed without reference to other features and subcombinations. This is contemplated by and is within the scope of the claims.

Since many possible embodiments may be made of the invention without departing from the scope thereof, it is to be understood that all matter herein set forth or shown in the accompanying drawings is to be interpreted as illustrative, and not in a limiting sense.

The invention claimed is:

1. A receptacle for holding a beverage and juice from a fruit, said receptacle comprising:
a hollow container body for receiving and holding the beverage therein, said container body having a top rim and an inside surface; and
a plurality of protrusions on said inside surface of the container body spaced below said rim, said protrusions having sizes and shapes to extract juice from the fruit by pressure when the fruit is rubbed against said protrusions.

2. A receptacle as set forth in claim 1, wherein said protrusions occupy a selected portion of said inside surface and said inside surface is smooth except for said selected portion thereof.

3. A receptacle is set forth in claim 1, wherein said protrusions are arranged in a plurality of rows and a plurality of columns with the protrusions in each of said rows and each of said columns being spaced apart.

4. A receptacle as set forth in claim 3, wherein:
each of said protrusions has a base adjacent to said inside surface and a tip spaced away from said inside surface; and
each of said protrusions tapers from said base to said tip thereof.

5. A receptacle as set forth in claim 4, wherein each of said tips presents a substantially flat surface.

6. A receptacle as set forth in claim 1, wherein:
each of said protrusions has a base adjacent to said inside surface and a tip spaced away from said inside surface; and
each of said protrusions tapers from said base to said tip thereof.

7. A receptacle as set forth in claim 6, wherein each of said tips presents a substantially flat surface.

8. A receptacle as set forth in claim 1, including a patch from which said protrusions extend, said patch being secured to said inside surface of the container body.

9. A receptacle as set forth in claim 8, wherein said protrusions are arranged on said patch in a plurality of rows and a plurality of columns with the protrusions in each row and the protrusions in each column spaced apart.

10. A receptacle as set forth in claim 9, wherein said patch is spaced below said rim by a distance in the range of approximately one-fourth to one-half inch.

11. A receptacle as set forth in claim 10, wherein said patch has a width dimension in the range of approximately one to one and one-half inches and a height dimension in the range of approximately one to one and one-half inches.

12. A receptacle as set forth in claim 8, wherein said patch has a width dimension in the range of approximately one to one and one-half inches and a height dimension in the range of approximately one to one and one-half inches.

13. A receptacle as set forth in claim 1, wherein said protrusions are located in an area on said inside surface of the container body that occupies a space in the range of approximately one to one and one-half inches wide and approximately one to one and one-half inches high.

14. A receptacle as set forth in claim 1, wherein each protrusion projects from said inside surface of the container body a distance of approximately one-eighth inch.

15. A drinking receptacle for a beverage and juice and pulp extracted from a citrus fruit, said receptacle comprising:
a hollow receptacle body for receiving the beverage, said body having a top rim and an inside surface; and
a plurality of protrusions occupying a selected area on the inside surface of said body spaced below said rim, said protrusions being spaced apart horizontally and vertically and being arranged to extract juice and pulp from the fruit by pressure when the fruit is rubbed against said protrusions.

16. A receptacle as set forth in claim 15, including a patch secured to said inside surface at said selected area, said protrusions being mounted on said patch.

17. A pitcher for holding a quantity of a beverage to which juice from a fruit can be added, said pitcher comprising:
a hollow container body for receiving and holding the beverage, said body having an inside surface and a top rim shaped to provide a spout for pouring of the beverage; and
a plurality of protrusions on said body occupying a selected area of said inside surface spaced below said rim and offset from said spout, said protrusions being constructed and arranged to extract juice by pressure from a fruit rubbed against the protrusions.

18. A pitcher as set forth in claim 17, wherein said protrusions are arranged on said selected area in a manner to space said protrusions apart horizontally and vertically.

19. A pitcher as set forth in claim 18, wherein said protrusions extend from a patch which is secured to said selected area.

20. A pitcher as set forth in claim 19, wherein said protrusions are arranged on said patch in a plurality of rows and a plurality of columns.
